(19) United States
(12) Patent Application Publication
(10) Pub. No.: US 2026/0105010 A1
(43) Pub. Date: Apr. 16, 2026

(54) INFORMATION PROCESSING METHOD, INFORMATION PROCESSING SYSTEM, AND STORAGE MEDIUM

(71) Applicant: DENSO CORPORATION, Kariya-city (JP)

(72) Inventors: Xin XU, Kariya-city (JP); Hayato SAKAMOTO, Kariya-city (JP)

(21) Appl. No.: 19/421,718

(22) Filed: Dec. 16, 2025

Related U.S. Application Data
(63) Continuation of application No. PCT/JP2024/017048, filed on May 8, 2024.

(30) Foreign Application Priority Data
Nov. 9, 2023 (JP) 2023-191815
Jun. 29, 2023 (JP) 2023-107363

(51) Int. Cl. G06F 12/14

(52) U.S. Cl. CPC G06F 12/1458

(57) ABSTRACT

An information processing system comprises: a data storage configured to sort storage target data into data types including at least deletion permission data and non-deletion data, and store the deletion permission data and the non-deletion data in association with a different channel of a blockchain; and a tempering check unit configured to record block number information related to a position of a processed block in which the storage target data associated with a corresponding deletion target block is deleted, and determine a start position of a check process.

### CROSS REFERENCE TO RELATED APPLICATIONS

The present application is a continuation application of International Patent Application No. PCT/JP2024/017048 filed on May 8, 2024, which designated the U.S. and claims the benefit of priority from Japanese Patent Application No. 2023-107363 filed on June 29, 2023 and the benefit of priority from Japanese Patent Application No. 2023-191815 filed on November 9, 2023. The entire disclosures of all of the above applications are incorporated herein by reference.

### TECHNICAL FIELD

The present disclosure relates a technology for storing data using a blockchain.

### BACKGROUND

In an information processing device as a comparative example, a registration blockchain distributed ledger on which a transaction registration process can be executed and a reference blockchain distributed ledger on which the transaction registration process cannot be executed are stored separately. This information processing device reduces the bloat of data stored using blockchain technology by deleting the reference blockchain distributed ledger.

### SUMMARY

According to an aspect of the present disclosure, an information processing system comprises: a data storage configured to sort storage target data into data types including at least deletion permission data and non-deletion data, and store the deletion permission data and the non-deletion data in association with a different channel of a blockchain; and at least one of (i) a circuit and (ii) a processor with a memory storing computer program code executable by the processor, the at least one of the circuit and the processor configured to cause the information processing system to record block number information related to a position of a processed block in which the storage target data associated with a corresponding deletion target block is deleted, and determine a start position of a check process.

### BRIEF DESCRIPTION OF DRAWINGS

FIG. 1 is a block diagram showing an overview of a blockchain platform in which an information processing method according to one embodiment of the present disclosure is executed.

FIG. 2 is a diagram for illustrating contents of a registration process of storage target data by a data registration unit.

FIG. 3 is a diagram for illustrating details of data storage by a blockchain node.

FIG. 4 is a diagram showing an example of sorting storage target data.

FIG. 5 is a diagram for illustrating contents of a data deletion process of the storage target data by the data deletion unit.

FIG. 6 is a diagram for illustrating contents of a tampering check process of storage target data by a tampering check unit.

FIG. 7 is a flowchart showing details of a data registration process executed by a data registration unit.

FIG. 8 is a flowchart showing details of a data deletion process executed by the data deletion unit.

FIG. 9 is a flowchart showing details of a tampering check process executed by the tampering check unit.

FIG. 10 is a diagram for illustrating contents of the deletion process of the storage target data according to a first modification.

FIG. 11 is a diagram for illustrating contents of a tampering check process.

### DETAILED DESCRIPTION

In the information processing device as the comparative example, the registration blockchain distributed ledger becomes the reference blockchain distributed ledger over time, and is subsequently deleted. That is, the old past data is uniformly deleted. Therefore, after deleting the past data, these tampering checks cannot be performed, and it may be difficult to confirm that the tampering with the past data has not been performed. As described above, there is a difficulty in the data deletion method of the comparative example.

An example of the present disclosure provides an information processing method, an information processing system, and a storage medium capable of appropriately deleting data stored by using blockchain technology.

According to one aspect of the present disclosure, an information processing method stores storage target data by using a technology of a blockchain, and the information processing method comprises a process that is executed by at least one processor and includes a plurality of steps of: sorting the storage target data into a plurality of data types including at least deletion permission data of which deletion is permitted and non-deletion data of which deletion is not permitted; storing each of the deletion permission data and the non-deletion data in association with a different channel of the blockchain; recording block number information related to a position of a processed block in which the storage target data associated with a corresponding deletion target block among a plurality of deletion target blocks is deleted, the plurality of deletion target blocks constituting a deletion target channel that stores the deletion permission data, and determining a start position of a check process based on the block number information in the check process of confirming tampering with the deletion target channel.

Further, according to another aspect of the disclosure, an information processing system stores storage target data by using a technology of a blockchain, and the information processing system comprises: a data storage configured to sort the storage target data into a plurality of data types including at least deletion permission data of which deletion is permitted and non-deletion data of which deletion is not permitted, and store each of the deletion permission data and the non-deletion data in association with a different channel of the blockchain; and a tampering check unit configured to record block number information related to a position of a processed block in which the storage target data associated with a corresponding deletion target block among a plurality of deletion target blocks is deleted, the plurality of deletion target blocks constituting a deletion target channel that stores the deletion permission data, and determine a start position of a check process based on the block number information in the check process of confirming tampering with the deletion target channel.

Further, according to another aspect of the disclosure, a storage medium stores an information processing program for storing storage target data using a technology of a blockchain and is readable by a computer, the information processing program causing at least one processor to execute a plurality of processes of: sorting the storage target data into a plurality of data types including at least deletion permission data of which deletion is permitted and non-deletion data of which deletion is not permitted; storing each of the deletion permission data and the non-deletion data in association with a different channel of the blockchain; a tampering check unit configured to record block number information related to a position of a processed block in which the storage target data associated with a corresponding deletion target block among a plurality of deletion target blocks is deleted, the plurality of deletion target blocks constituting a deletion target channel that stores the deletion permission data, and determining a start position of a check process based on the block number information in the check process of confirming tampering with the deletion target channel.

In these aspects, when the storage target data is deleted, block number information related to the position of the processed block is recorded in the deletion target channel for storing the deletion permission data. Therefore, by determining the start position of the check process based on the block number information, even after the storage target data is deleted, it is possible to perform the tampering check of the deletion target channel, and confirm that the tampering has not been performed. Accordingly, it may be possible to appropriately delete the data stored by using the blockchain technology.

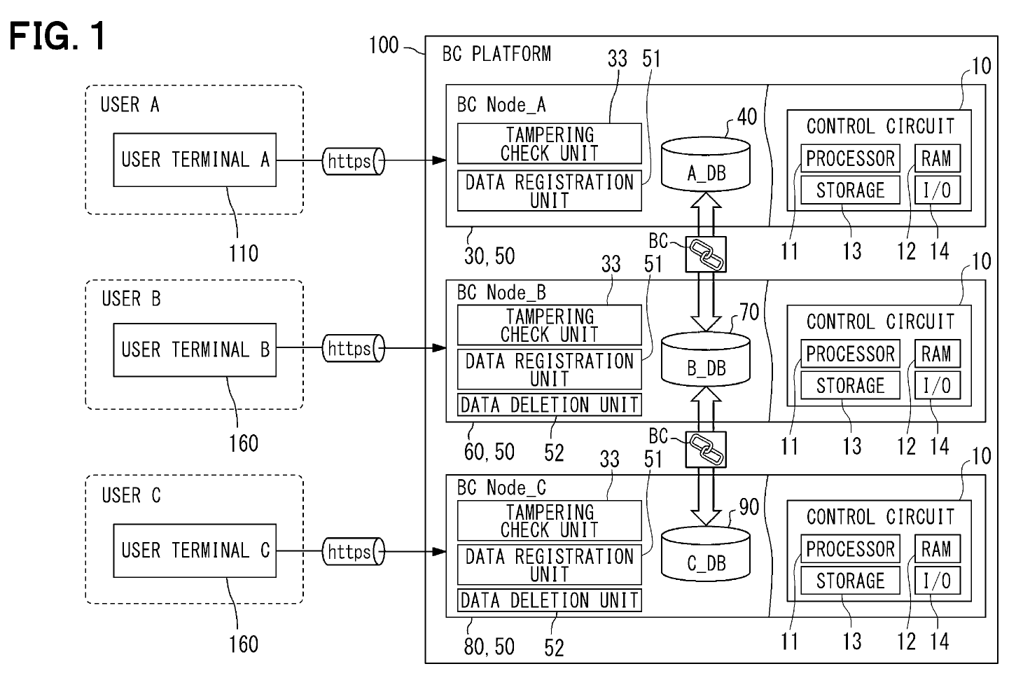

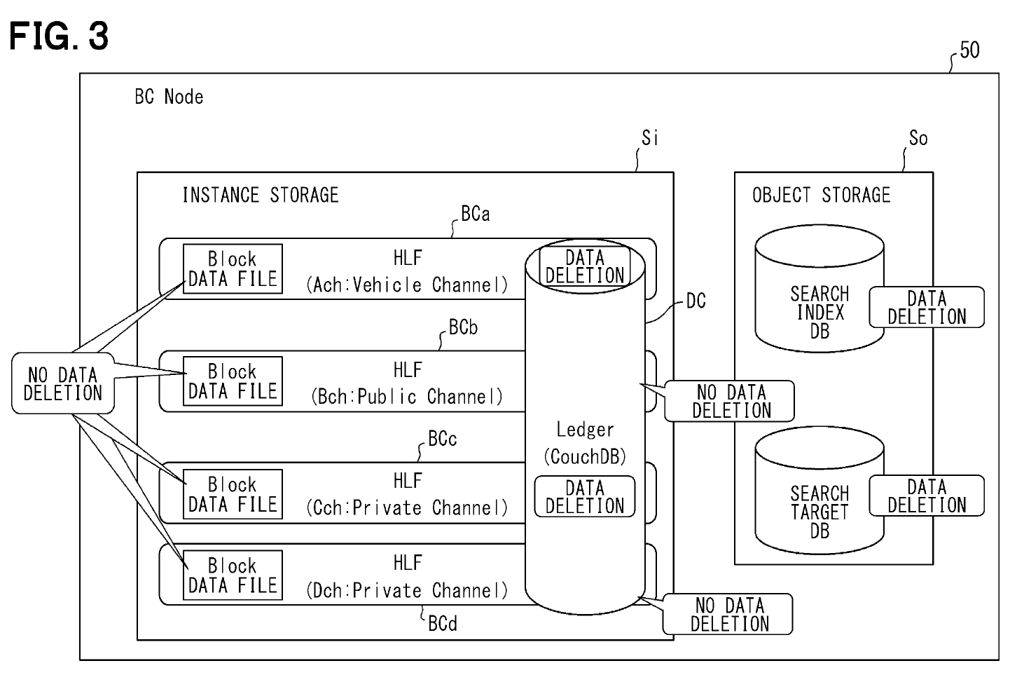

A blockchain platform 100 according to one embodiment of the present disclosure shown in FIG. 1 enables information sharing between clients (for example, companies) that become participants using a technology of a blockchain BC. For example, a framework of a general-purpose blockchain BC such as Hyper Ledger Fabric (HLF, see FIG. 3) is used for the blockchain platform 100. In the blockchain platform 100, a private blockchain network (hereinafter referred to as a channel) can be established in which only specific participants can participate in the network and share data and transactions. As described above, it is possible to satisfy the privacy and confidentiality requirements of each participant.

The blockchain platform 100 includes multiple blockchain nodes (hereinafter referred to as BC nodes) 50. Each BC node 50 is constructed by, as one example, a blockchain server (virtual machine) on the cloud. The blockchain server mainly includes a control circuit 10. The control circuit 10 includes a processor 11, a RAM 12, a storage 13, an input/output interface 14, and a bus connecting these components, and functions as a high-performance computer that executes calculation processing at high speed.

The processor 11 is hardware for calculation processing coupled with the RAM 12. The processor 11 accesses the RAM 12 to execute various processes (instructions) related to data management and data provision. The storage 13 stores an information processing program that implements functions related to data management and provision. The information processing program is a program for causing a blockchain server (control circuit 10) to implement the information processing method of the present disclosure.

The BC node 50 is a blockchain management system linked to a system of each client. In one example, in a blockchain network that manages vehicle information, a client (users B and C shown in FIG. 1) is an automobile manufacturer (Original Equipment Manufacture, OEM) that manufactures the vehicle, a dealer that sells the vehicle, or the like. One of the multiple BC nodes 50 is a BC node 60 (Node_B in FIG. 1), which cooperates with a user terminal 160 (user terminal B in FIG. 1) of the OEM management system. Further, another one of the multiple BC nodes 50 is a BC node 80 (BC, Node_C in FIG. 1) that cooperates with the user terminal 160 (user terminal C in FIG. 1) of the dealer management system.

The BC node 60 includes a node database 70 (B_DB in FIG. 1). The node database 70 stores storage target data DS associated with the user B and enables the storage target data DS to be shared with other BC nodes 50. Similarly, the BC node 60 includes a node database 90 (C_DB in FIG. 1). The node database 90 stores the storage target data DS associated with the user C, and enables the storage target data DS to be shared with other BC nodes 50. The storage target data DS is data stored and shared on the blockchain platform 100 using the technology of the blockchain BC. The storage target data DS is collected at each user terminal and transmitted to the BC node 50 associated with each user terminal.

The BC node 50 receives new registration requests, update requests, reference requests, and deletion requests for the storage target data DS from the user terminal 160 of each user. The BC node 50 includes functional units such as a data registration unit 51 and a data deletion unit 52. A BC node 30 described later may include the data registration unit 51 similarly to the other BC nodes 50.

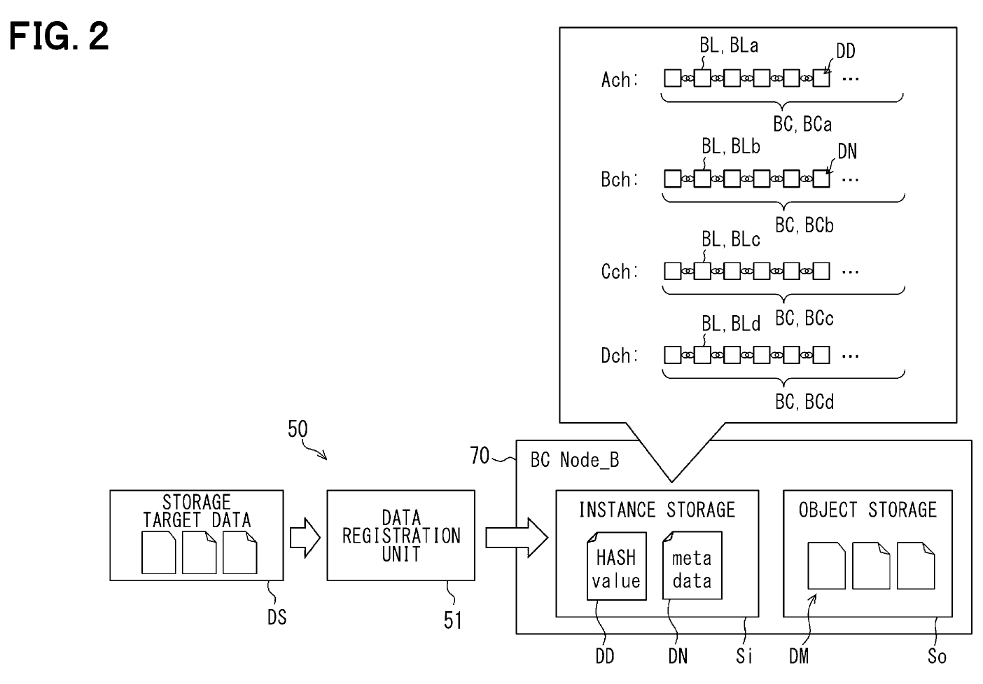

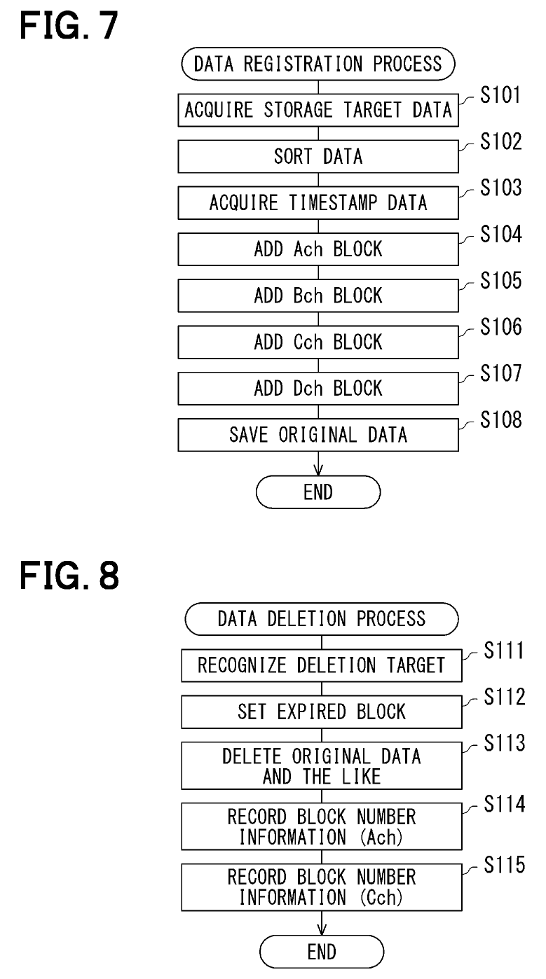

As shown in FIG. 2, the data registration unit 51 receives a new registration request for the storage target data DS from the user terminal 160 or the like. The data registration unit 51 executes a registration process (see FIG. 7) of the storage target data DS based on the registration request. The data registration unit 51 prepares original data DM, metadata, and hash values from the storage target data DS.

The original data DM is the main portion of the storage target data DS, and is the raw data of the storage target data DS. Specifically, multimedia data having a large data size, such as document data such as PDF format, image data such as JPEG format, music data such as MPEG format, and video data, is referred to as the original data DM.

The metadata is data that provides information related to the storage target data DS (original data DM). The metadata is data related to storing the storage target data DS in the blockchain BC, and specifically, is generated in response to a registration use process such as registration (connection) of the storage target data DS, an operation such as search, and authentication of the data and the user. In the blockchain network that manages the vehicle information described above, the metadata is related data of the blockchain BC other pure vehicle information.

The metadata is closely related to the structure of the blockchain BC. Deleting the metadata may affect the blockchain BC. Specifically, summary data indicating the contents, characteristics, structure, relationship, and the like of the storage target data DS, operation data related to this summary data, data and user authentication information, and the like are prepared as metadata. The summary data includes, for example, a data name (file name) of the original data DM, a creation date and time, a data size, a data format (extension), and the like. The operation data records the execution history of, for example, a registration operation with the blockchain BC, ID assignment, data authentication, data search, and the like. The authentication information is information related to a public key and the assigned ID. The metadata may be generated by the user terminal 160 or by the data registration unit 51 using the storage target data DS provided by the user terminal 160.

The hash value is generated using the original data DM. The hash value is data in which a predetermined number of bits (for example, 256 bits) are maintained and has a value in which the content of the original data DM is reflected. For example, a hash function such as SHA-256 is used to generate the hash value. Instead of SHA-256, an encryption algorithm (hash function) such as SHA-1, SHA-2, SHA-3, and SHA-512 may be used to generate the hash value.

The data registration unit 51 sorts the storage target data DS into multiple data types including at least deletion permission data DD and deletion non-target data DN. The deletion permission data DD is data of which deletion is permitted based on the passage of a predetermined period or a specific deletion trigger. The deletion permission data includes the hash value described above. The deletion non-target data DN is non-deletion target data of which deletion is not permitted, and is substantially permanently stored. The deletion non-target data DN includes the metadata described above.

The data registration unit 51 stores the original data DM, hash values, and metadata in different data storage areas (storages) of the node database 70. Specifically, the original data DM having the large data size is stored in an object storage So. On the other hand, metadata and hash values, which are small in data size and desired to be shared between participants without tampering, are stored in an instance storage Si.

The object storage So shown in FIGS. 2 and 3 is a storage that stores files and data as objects. In one example, the object storage So includes a search index database So1 and a search target database So2. The search index database So1 stores data necessary for searching information stored in the search target database So2. That is, information associated with the object (original data DM) stored in the search target database So2 is stored in the search index database So1. For example, an RDS (Relational Database Service) can be used as the search index database So1. The RDS is a relational database provided on AWS (Amazon Web Services, registered trademark). For example, a S3 (Simple Storage Service) bucket can be used for the search target database So2. The S3 bucket is provided on the AWS similarly to the RDS, and can permanently store a large amount of data. The data stored in the object storage So is not shared with other BC nodes 50. Instead of the RDS and S3 buckets, other cloud storages such as Azure Blob Storage of Azure (registered trademark) may be used, for example.

The instance storage Si is a local storage of the blockchain server. Instead of the instance storage Si, a block storage that stores blockchain server data in blocks on the cloud may be used. In this case, as the instance storage Si, EBS (Elastic Block Store) of AWS, Azure Managed Disks of Azure, and the like can be used. The data stored in the instance storage Si can be shared with other BC nodes 50.

The data registration unit 51 separately stores the deletion permission data DD including the hash value and the deletion non-target data DN including metadata in different channels of the blockchain BC. Conveniently, the network of the blockchain BC that stores the deletion permission data DD is set to a first blockchain channel (hereinafter referred to as A-channel BCa) dedicated to the deletion permission data DD. The network of the blockchain BC that stores the deletion non-target data DN is referred to as a second blockchain channel (hereinafter referred to as B-channel BCb) dedicated to the deletion non-target data DN. Both the A-channel BCa and the B-channel BCb are public channels in which data is shared with other BC nodes 50.

Each block BL (hereinafter referred to as Ach block BLa) constituting the A-channel BCa stores the deletion permission data DD as a transaction. The deletion permission data DD is registered as block data of the A-channel BCa, and is also stored in a ledger DC (see FIG. 3) provided in a distributed database such as Couch DB. In the A-channel BCa, the hash value generated from one Ach block BLa is stored in the next Ach block BLa. Furthermore, timestamp data indicating the date and time when the deletion permission data DD is added is recorded in the Ach block BLa.

The individual blocks BL (hereinafter referred to as Bch blocks BLb) constituting the B-channel BCb store the deletion non-target data DN as a transaction. The deletion non-target data DN is registered as block data of the B-channel BCb and also stored in the ledger DC. In the B-channel BCb, the hash value generated from one Bch block BLb is stored in the next Bch block BLb. Furthermore, timestamp data indicating the date and time when the deletion non-target data DN is added is also recorded in the Bch block BLb.

The timestamp data may be simply information indicating the date and time, or may be a hash value generated by a timestamp server or the like. The timestamp server takes a news article distributed by a news distribution server or the like as input information, and generates a hash value having a predetermined number of bits (for example, 256 bits) as timestamp data by a process of inputting this input information to a hash function.

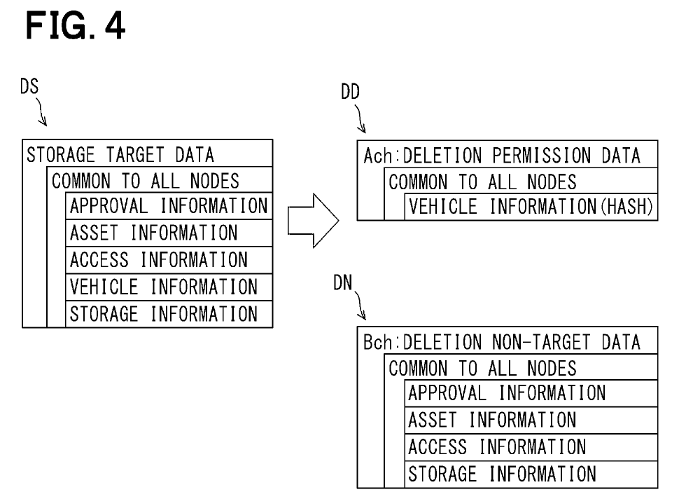

Here, in the blockchain network that manages vehicle information, approval information, asset information, access information, and other storage information are included in the storage target data DS together with the vehicle information (see FIG. 4). The data registration unit 51 sets the hash value based on the vehicle information to the deletion permission data DD. Then, the hash value based on the vehicle information is stored in the A-channel BCa. The A-channel BCa becomes a vehicle channel for storing vehicle information. As an example, the vehicle information that becomes the original data DM includes a vehicle body number, year, grade, vehicle name, traveling distance, collision detection result, registered inspection result, registered photograph, assessment price, and the like. Furthermore, the data registration unit 51 sets the approval information, asset information, access information, other storage information, and the like to the deletion non-target data DN. Then, the information is stored in the B-channel BCb.

The data registration unit 51 can also store data in channels separate from the A-channel BCa and the B-channel BCb, specifically, stores data in a C-channel BCc and a D-channel BCd. The C-channel BCc and the D-channel BCd are private channels, different from public channels such as the A-channel BCa and the B-channel BCb. The C-channel BCc and the D-channel BCd are channels that store non-disclosure information that is not disclosed to other BC nodes 50, such as trade secrets and key information. The C-channel BCc is a private channel corresponding to the A-channel BCa, and the deletion permission data DD of the non-disclosure information is stored. The D-channel BCd is a private channel corresponding to the B-channel BCb, and the deletion non-target data DN of the non-disclosure information is stored.

The non-disclosure information stored in the C-channel BCc and the D-channel BCd may be raw data such as trade secrets and key information, or may be hash values generated from trade secrets, key information, and the like. The raw data of the non-disclosure information is stored in the object storage So as the original data DM. The non-disclosure information is disclosure limitation information indicating that the disclosure target for the deletion permission data DD and the deletion non-target data DN is limited. The non-disclosure information is stored as a transaction together with timestamp data and the like in each block BL (hereinafter, Cch block BLc) configuring the C-channel BCc or each block BL (hereinafter, Dch block BLd) configuring the D-channel BCd. The non-disclosure information is registered as block data of the C-channel BCc and the D-channel BCd, and is also stored in the ledger DC (see FIG. 3).

The C-channel BCc may be a private channel used for data sharing within a specific group. In this case, only a part of all the BC nodes 50 and the BC nodes 50 in the preset sharing group can access the C-channel BCc and the D-channel BCd. Further, when the non-disclosure information does not include the deletion non-target data DN or when the non-disclosure information includes only a small amount of the deletion non-target data DN, the D-channel BCd may not be provided.

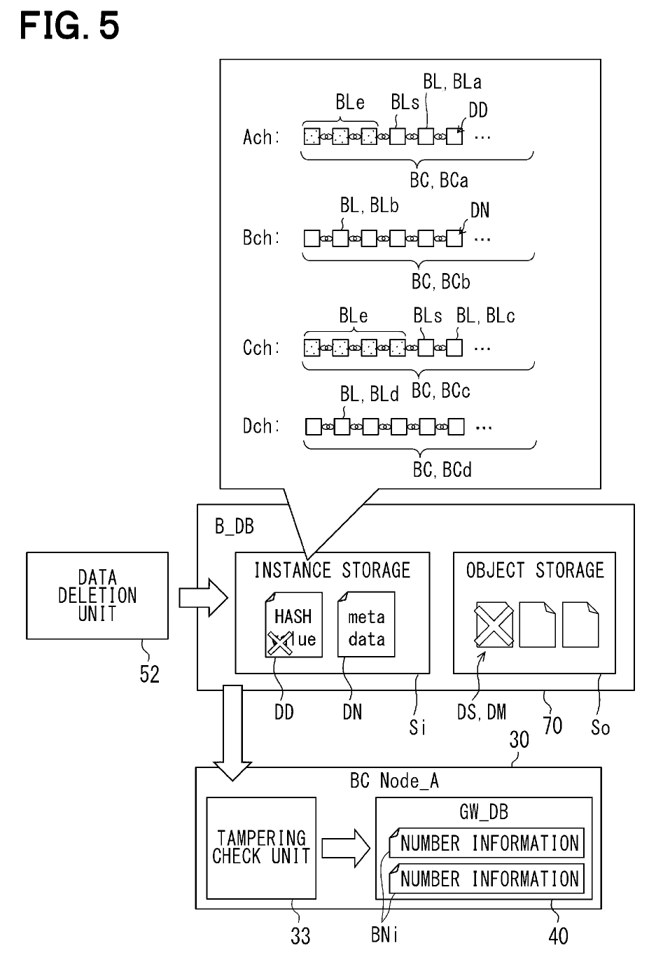

As shown in FIG. 3 and FIG. 5, the data deletion unit 52 executes a deletion process (see FIG. 8) for deleting some of the storage target data DS. The data deletion unit 52 may automatically delete storage target data DS after a certain period (for example, seven years) has elapsed since it was stored, or may delete the old storage target data DS based on the deletion request received from the user terminal 160 or the BC node 30 described later.

The data deletion unit 52 sets, to the deletion target, the storage target data DS stored before the specific time based on the predetermined period conditions or the conditions specified in the deletion request. When deleting the storage target data DS, the data deletion unit 52 sets, to the deletion target, only the data stored in association with the A-channel BCa and the C-channel BCc. In other words, the data deletion unit 52 does not set, to the deletion target, the data stored in association with the B-channel BCb.

More specifically, the data deletion unit 52 determines the range of block BL to be processed in the A-channel BCa and the C-channel BCc based on the timestamp data stored in each Ach block BLa and each Cch block BLc. Each of the blocks BLa and BLc to be processed becomes an expired block BLe (see dot in FIG. 5). The data deletion unit 52 targets the data group associated with the blocks BLa and BLc set as the processing targets. On the other hand, the data deletion unit 52 does not set the blocks BLa and BLc (block data files, see FIG. 3) themselves to the deletion targets. When the timestamp data of the storage target data DS is stored in the object storage So, the data deletion unit 52 may determine the data group to be deleted using the timestamp data of the object storage So.

The data deletion unit 52 deletes, from the ledger DC, the deletion permission data DD corresponding to the duplication of block data included in the Ach block BLE (expired block BLe), which is the processing target. In addition, the data deletion unit 52 deletes the original data DM from the object storage So. The original data DM is the storage target data DS associated with the Ach block BLa and used for generating the deletion permission data DD stored in the Ach block BLa that is the processing target.

Similarly, the data deletion unit 52 deletes, from the ledger DC, non-disclosure information corresponding to duplication of block data included in the Cch block BLc (expired block BLe), which is the processing target. In addition, the data deletion unit 52 deletes, from the object storage So, the original data DM associated with the Cch block BLc that is the processing target and used for generating the non-disclosure information.

As described above, the original data DM and the like associated with the A-channel BCa or the C-channel BCc are deleted when the storage period expires. Thereby, multimedia data such as document data, image data, music data, and video data having a large data size can be deleted from the search index database So1 and the search target database So2 of the object storage So. In contrast, the data associated with the B-channel BCb includes not only the block data contained in Bch blocks BLb, but also the deletion non-target data DN and its original data DM stored in the ledger DC. These data remain stored without being deleted, even after the storage period has expired.

The data deletion unit 52 recognizes block number information BNi related to the position of the Ach block BLa whose deletion permission data DD and original data DM have been deleted in the ledger DC among the multiple Ach blocks BLa configuring the A-channel BCa. Similarly, the data deletion unit 52 recognizes the block number information BNi related to the position of the Cch block BLc whose non-disclosure information and original data DM are deleted in the ledger DC among the multiple Cch blocks BLc configuring the C-channel BCc. The data deletion unit 52 sets each block BLe, BLc from which the original data DM is deleted as an expired block BLe (see dots in FIG. 5). The block number information BNi is information indicating the boundary position between the range of the expired block BLe and the range of the block BL in which the original data DM has not been deleted for each of the A-channel BCa and the C-channel BCc.

As one example, the data deletion unit 52 sets the oldest block BL to the specific block BLs among the many Ach blocks BLa or Cch blocks BLc that are not expired blocks BLe (see FIG. 5). Further, as another example, the data deletion unit 52 sets the latest block BL among the expired blocks BLe to the specific block BLs. The data deletion unit 52 acquires a unique block number indicating the specific block BLs as the block number information BNi. The data deletion unit 52 provides the acquired block number information BNi to the BC node 30 described later. The block number information BNi may be shared between multiple BC nodes 50 using the blockchain BC.

The BC node 30 is a BC node 50 that manages access to the blockchain platform 100 by a user terminal 110 (user terminal A in FIG. 1) of an external system or an external user (user A in FIG. 1). The BC node 30 performs authentication and authorization of connection to the blockchain platform 100 by the external system or the user terminal 110. The BC node 30 acquires reference requests and the like for the storage target data DS stored by the blockchain BC from the external system and the user terminal 110. The BC node 30 generates provision data from the storage target data DS based on the reference request, and provides the generated provision data to the external system or user terminal 110 that is the request source.

The BC node 30 includes a functional unit such as a node database 40 and a tampering check unit 33. The node database 40 is a data storage area that stores information related to the BC node 30. At least a part of the data stored in the node database 40 is shared with the node databases 70, 90, and the like.

As shown in FIG. 5, the tampering check unit 33 acquires the block number information BNi when the data deletion unit 52 deletes a part of the storage target data DS. The tampering check unit 33 may directly acquire the block number information BNi from the data deletion unit 52 that has executed the deletion process, or may acquire the block number information BNi by sharing information via the blockchain BC. The tampering check unit 33 records the acquired block number information BNi in the node database 40. As one example, the tampering check unit 33 registers the block number information BNi in the private channel of the node database 40. The tampering check unit 33 updates the block number information BNi associated with the A-channel BCa when the data deletion unit 52 newly executes the deletion process of the original data DM or the like associated with the Ach block BLa. Similarly, when the data deletion unit 52 newly executes the deletion process of the original data DM or the like associated with the Cch block BLc, the tampering check unit 33 updates the block number information BNi associated with the C-channel BCc.

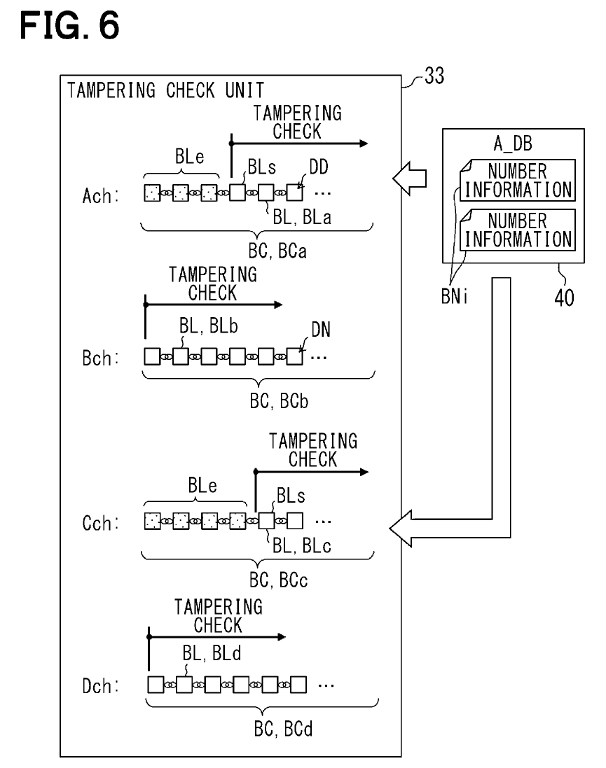

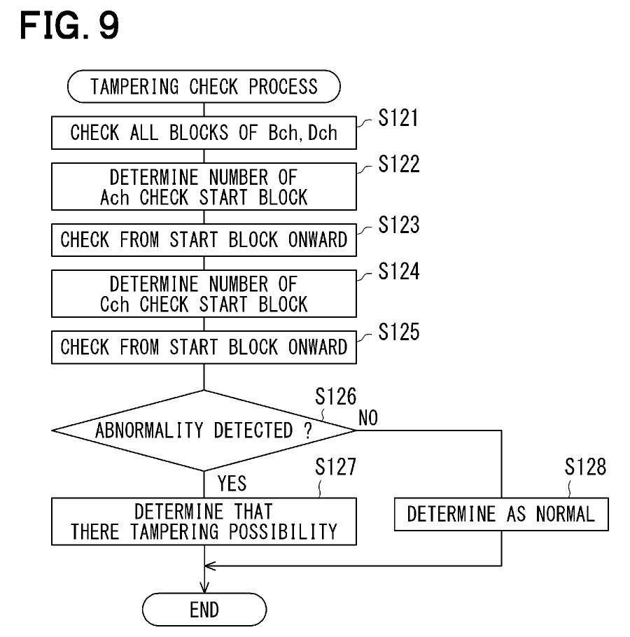

As shown in FIG. 6, the tampering check unit 33 executes a tampering check process (see FIG. 9) to confirm whether the tampering with the storage target data DS has been performed at a predetermined timing or based on a check request from the external system or the user terminal 110. Specifically, the tampering check unit 33 repeats the recalculation of the hash value of each block BL using the data in each block BL (the hash value of the transaction and the previous block) and the hash function used when generating the blockchain BC. The tampering check unit 33 determines whether there is the tampering by verifying whether the hash values of each block BL are correctly connected.

The tampering check unit 33 starts recalculating the hash value from the old Bch block BLb located at the first position of the B-channel BCb in the check process of confirming the tampering with the B-channel BCb. On the other hand, in the check process of confirming the tampering with the A-channel BCa and the C-channel BCc, the tampering check unit 33 determines the start position (start block) of the check process based on the block number information BNi.

As described above, when the block number information BNi indicates the block numbers of the oldest valid blocks BLa and BLc, the tampering check unit 33 sets the specific block BLs indicated by the block number information BNi as the start block of the check process. Further, when the block number information BNi indicates the block number of the latest expired block BLe, the tampering check unit 33 sets the next block BLa, BLc to the specific block BLs indicated by the block number information BNi as the start block of the check process. The tampering check unit 33 recalculates the hash value from the determined start block. In other words, the expired block BLe is not subject to the check process of confirming whether there is the tampering.

The tampering check unit 33 is also provided in the BC node 50 other than the BC node 30. Such a tampering check unit 33 can also execute the process for the tampering check. Similarly, the BC node 30 may have the function of the data deletion unit 52 and may be capable of executing the data deletion process.

Next, the details of the data registration process, the data deletion process, and the tampering check process described so far will be described based on FIGS. 7 to 9 and with reference to FIGS. 1 to 6.

The data registration process shown in FIG. 7 is mainly executed by the data registration unit 51 (see FIG. 2). In S101, the data registration unit 51 acquires the storage target data DS from the user terminal 160 by receiving it. In S102, the data registration unit 51 sorts the acquired storage target data DS into multiple data types including at least the deletion permission data DD and the deletion non-target data DN. When the acquired storage target data DS includes non-disclosure information, the data registration unit 51 sorts this non-disclosure information as data of a type different from the deletion permission data DD and the deletion non-target data DN in S102. Furthermore, in S103, the data registration unit 51 acquires timestamp data indicating the acquisition timing or the storage timing of the storage target data DS.

In S104 and S105, the deletion permission data DD and the deletion non-target data DN are stored separately in different channels of the blockchain BC (public chain). Specifically, in S104, the data registration unit 51 adds a new Ach block BLa to the A-channel BCa that stores the current deletion permission data DD. Furthermore,

in S105, the data registration unit 51 adds a new Bch block BLb that stores the current deletion non-target data DN to the B-channel BCb.

In S106 and S107, the non-disclosure information is stored in a private chain prepared separately from the public chain. In S106, the data registration unit 51 adds a new Cch block BLc that stores the current non-disclosure information to the C-channel BCc. Furthermore, in S107, the data registration unit 51 adds a new DCh block BLd that stores the current non-disclosure information to the D-channel BCd. When the storage target data DS does not include the non-disclosure information, the processes in S106 and S107 are omitted. Further, the data registration process of adding the non-disclosure information to the C-channel BCc and the D-channel BCd may be executed as a process separate from the data registration process of adding the deletion permission data DD and the deletion non-target data DN to the public channel.

In S104 to S107 described above, the timestamp data acquired in S103 is recorded in each block BL to be added. Then, in S108, the data registration unit 51 stores the original data DM associated with the deletion permission data DD, the deletion non-target data DN, the non-disclosure information, and the like in the object storage So. The execution order of S104 to S108 may be changed as appropriate.

The data deletion process shown in FIG. 8 is mainly executed by the data deletion unit 52 (see FIG. 5). The data deletion unit 52 recognizes the storage target data DS to be the deletion target in S111. In one example, when performing periodic data deletion due to the lapse of a predetermined period, the data deletion unit 52 refers to the timestamp data recorded in each Ach block BLa and identifies the Ach block BLa according to the deletion period. Similarly, the data deletion unit 52 refers to the timestamp data recorded in each Cch block BLc, and identifies the Cch block BLc according to the deletion period. Even when deleting data based on a specific deletion trigger, the data deletion unit 52 refers to the timestamp data of each Ach

block BLa and each Cch block BLc, and identifies the Ach block BLa and Cch block BLc according to the specified deletion period.

The data deletion unit 52 sets the Ach block BLa and the Cch block BLc according to the deletion period in S111 to the expired block BLe in S112. In S113, the data deletion unit 52 deletes the storage target data DS associated with the expired block BLe, that is, the deletion permission data DD, non-disclosure information, the original data DM, and the like. In S112 and S113 described above, among the A-channel BCa storing the deletion permission data DD and the B-channel BCb storing the deletion non-target data DN, the expired block BLe is set only in the A-channel BCa, and the deletion of the original data DM is applied. The execution order of S112 and S113 may be changed as appropriate. Specifically, after the deletion of the original data DM or the like according to the deletion period, the corresponding block BL may be set to the expired block BLe.

In S114 and S115, the tampering check unit 33 records block number information BNi indicating the start position (start block) of the tampering check, which is block number information BNi related to the position of the current set expired block BLe. When the expired block BLe is newly set in the A-channel BCa, the tampering check unit 33 updates the block number information BNi associated with the A-channel BCa in S114. Similarly, when the expired block BLe is newly set in the C-channel BCc, the tampering check unit 33 updates the block number information BNi associated with the C-channel BCc in S115.

The tampering check process shown in FIG. 9 is mainly executed by the tampering check unit 33 (see FIG. 6). In S121, the tampering check unit 33 checks whether the tampering is present for all Bch blocks BLb of the B-channel BCb and all Dch blocks BLd of the D-channel BCd. That is, the tampering check unit 33 calculates the hash value for the tampering check based on the block data stored in each block BL from the first Bch block BLb of the B-channel BCb and the first Dch block BLd of the D-channel BCd. The tampering check unit 33 compares the hash value recorded

in each block BL with the hash value for the tampering check, and determines that there is no tampering possibility when there is a match.

In S122, the tampering check unit 33 refers to the block number information BNi associated with the A-channel BCa, and determines the number (start position) of the start block for starting the tampering check of the A-channel BCa. In S123, the tampering check unit 33 checks whether there is the tampering for the Ach block BLa after the start block (specific block BLs) of the A-channel BCa. That is, the tampering check unit 33 excludes the expired block BLe from the tampering check. Then, the tampering check unit 33 calculates the hash value for the tampering check using the block data stored in each block BL after the specific block BLs. The tampering check unit 33 compares the hash value recorded in each block BL with the hash value for the tampering check, and determines that there is no tampering possibility when there is a match.

In S123, the tampering check unit 33 refers to the block number information BNi associated with the C-channel BCc, and determines the number (start position) of the start block for starting the tampering check of the C-channel BCc. In S124, the tampering check unit 33 checks whether there is the tampering check for the Cch block BLc after the specific block BLs of the C-channel BCc. As a result, the expired block BLE of the C-channel BCc is not subject to the tampering check.

The execution order of the check process of the B-channel BCb in S121, the check process of the A-channel BCa in S122 and S123, and the check process of C-channel BCc in S124 and S125 may be changed as appropriate. In addition, the check process of the C-channel BCc, which is a private chain, may be executed as a process separate from the check processes of the A-channel BCa and the B-channel BCb, which are public chains.

In S126, the tampering check unit 33 determines whether an abnormality is detected in the concatenation of hash values in each of the A-channel BCa, the B-channel BCb, the C-channel BCc, and the D-channel BCd. When the abnormality is

detected in the linking of hash values in at least one of the A-channel BCa, the B-channel BCb, the C-channel BCc, or the D-channel BCd (YES in S126), the tampering check unit 33 determines in S127 that there is the tampering possibility. When starting the tampering check process based on a request from the BC node 30, the user terminal 160, or the like, the tampering check unit 33 transmits an abnormality detection notification indicating the tampering possibility to these check request sources.

On the other hand, when no abnormality is detected in the linking of the hash values in all of the A-channel BCa, the B-channel BCb, the C-channel BCc, and the D-channel BCd (NO in S126), the tampering check unit 33 determines in S128 that there is no tampering possibility. That is, the tampering check unit 33 determines that the storage target data DS is normal in S128. In this case, the tampering check unit 33 may transmit a normal determination notification indicating that there is no tampering possibility to the check request source such as the BC node 30 or the user terminal 160.

### Overview of Embodiment

In the present embodiment described so far, when the storage target data DS is deleted, block number information BNi related to the position of the expired block BLe is recorded in the Ach block BLa that stores the deletion permission data DD. Therefore, by determining the start position of the check process based on the block number information BNi, even after the storage target data DS is deleted, the tampering check of the A-channel BCa can be performed, and it can be confirmed that the tampering has not been performed. Accordingly, it becomes possible to appropriately delete the data stored by using the technology of the blockchain BC.

More specifically, by newly establishing an A-channel BCa dedicated to the deletion permission data DD and managing it separately from the deletion non-target data DN, it is possible to reduce the amount of data to be stored and also ensure reliability by the tampering check. That is, even when the amount of data stored by

the BC node 50 participating in the blockchain BC increases in proportion to the number of all transactions processed by the blockchain BC, it becomes possible to sequentially execute the data deletion process and reduce the amount of data. Therefore, it is possible to avoid a situation where the cost required for data storage becomes huge, and it is possible to lower the economic hurdle for data storage using the blockchain BC. Thereby, the bar for establishing the BC node 50 is also lowered. Therefore, it is possible to avoid a situation where the consensus formation of the blockchain BC becomes unstable due to the decrease in the number of nodes.

In addition, since the block number information BNi indicating the position of the expired block BLe is recorded, it becomes possible to start the tampering check process of the A-channel BCa from an appropriate position. Therefore, it is possible to avoid a situation where it becomes difficult to normally execute the tampering check process due to the deletion of the data. Furthermore, in the A-channel BCa, the tampering check process can be applied without leakage to the range of Ach block BLa where it can be determined whether the tampering is present.

Further, among the storage target data DS, only the deletion permission data DD associated with the A-channel BCa is the deletion target, and the deletion non-target data DN associated with the B-channel BCb is not the deletion target. As a result, the storage target data DS related to the B-channel BCb continues to be stored permanently. Therefore, even after a part of the storage target data DS is deleted, it is possible to confirm that the tampering with the deleted storage target data DS has not been performed by performing the tampering check using the blockchain BC of the B-channel BCb.

Furthermore, in the present embodiment, the original data DM related to the deletion permission data DD is stored in the object storage So different from the instance storage Si that stores the deletion permission data DD. Then, the original data DM associated with the expired block BLe is deleted from the object storage So.

In this way, by appropriately deleting the original data DM having the large data size, it is possible to effectively reduce the amount of data to be accumulated.

In addition, the deletion permission data DD of the present embodiment includes a hash value generated from the original data DM. On the other hand, the deletion non-target data DN includes metadata related to the original data DM. According to the above, the metadata is permanently stored in a state where it is protected from the tampering.

Further, in the present embodiment, non-disclosure information whose disclosure target is limited to the deletion permission data DD is stored in association with the C-channel BCc different from the Ach block BLa. Therefore, it is possible to securely store even trade secrets and the like that cannot be disclosed to other BC nodes 50 by using the technology of the blockchain BC.

Furthermore, in the present embodiment, block number information BNi related to the position of the expired block BLe in which the non-disclosure information has been deleted among the multiple Cch blocks BLc configuring the C-channel BCc is recorded. In the check process of confirming the tampering with the Cch block BLc, the start position of the check process is determined based on the block number information BNi. According to the above, similarly to the original data DM of the deletion permission data DD, it becomes possible to delete the non-disclosure information stored by the C-channel BCc. As a result, it is possible to effectively reduce the amount of data to be accumulated.

Further, in the present embodiment, the object storage So is secured separately from the instance storage Si capable of sharing information between the BC nodes 50. Then, the original data DM is stored in the object storage So separately from the hash value and metadata. According to the storage configuration described above, the hash value and metadata that need to be shared and the original data DM with the large data size can be appropriately stored.

In the above embodiment, the data registration unit 51 corresponds to a "data storage", the A-channel BCa corresponds to a "deletion target channel", the C-channel BCc corresponds to a "disclosure limitation channel", and the non-disclosure information corresponds to "disclosure limitation information". Further, the Ach block BLa corresponds to a "deletion target block", the Cch block BLc corresponds to a "disclosure limitation block", the expired block BLe corresponds to a "processed block", and the deletion non-target data DN corresponds to "non-deletion data". The instance storage Si corresponds to a "first storage", the object storage So corresponds to a "second storage", the blockchain platform 100 corresponds to an "information processing system", and the storage 13 corresponds to a "storage medium".

### Other Embodiments

Although one embodiment of the present disclosure has been described above, the present disclosure is not construed as being limited to the above-described embodiment, and can be applied to various embodiments and combinations within a scope that does not depart from the gist of the present disclosure.

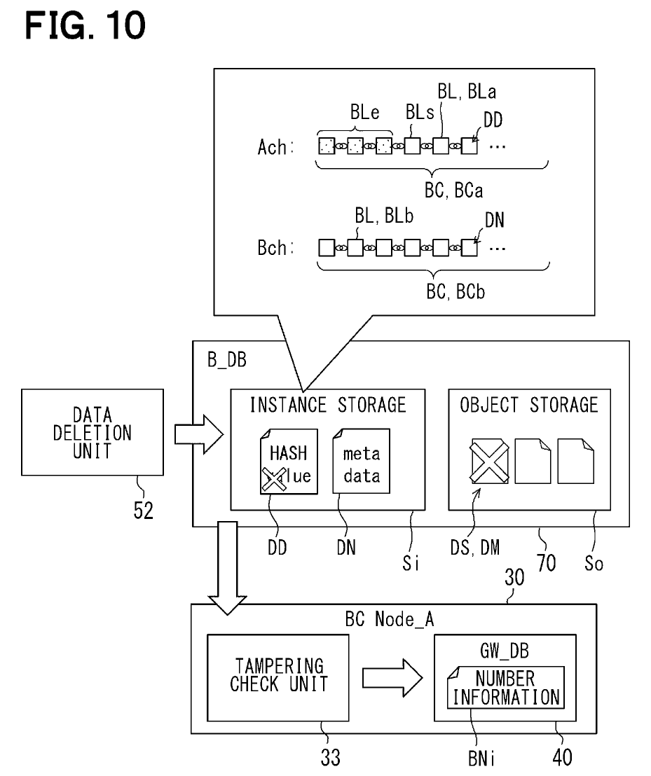

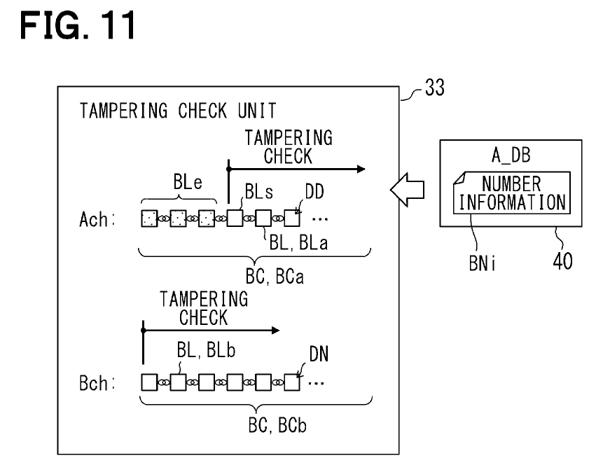

In the blockchain platform 100 according to the first modification of the above embodiment, the construction of the private channel is omitted. In the first modification shown in FIG. 10 and FIG. 11, the non-disclosure information is securely stored using a technology different from that of the blockchain BC. In one example, non-disclosure information of individual clients is stored in a database managed by each client.

The data deletion unit 52 shown in FIG. 10 sets an expired block BLe for only the A-channel BCa among the A-channel BCa and the B-channel BCb, and deletes the original data DM and the like associated with the expired block BLe. Further, the tampering check unit 33 shown in FIG. 11 performs the tampering check with the Ach block BLa after the specific block BLs and the tampering check with all Bch blocks BLb.

As in the first modification described above, the number of channels of the blockchain BC constructed on the blockchain platform 100 may be changed as appropriate. For example, multiple private channels with different BC nodes 50 sharing data may be set in the blockchain platform 100. Furthermore, multiple public channels corresponding to the A-channel BCa of the above embodiment may be set, which allow deletion of the associated original data DM.

In a second modification of the above embodiment, the original data DM is stored in the instance storage Si. That is, in the second modification, the storage configuration corresponding to the object storage So is omitted. The original data DM is treated as deletion permission data DD in the instance storage Si. Then, the original data DM is stored in the Ach block BLa as a transaction of the A-channel BCa. As in such a second modification, the configuration of the storage for storing the storage target data DS may be changed as appropriate according to the content of the storage target data DS.

In a third modification of the above embodiment, the block number information BNi is not recorded. The tampering check unit 33 of the third modification grasps the states of the A-channel BCa and the C-channel BCc each time in the tampering check process, and determines the start position of the check process to be executed for each channel without depending on the block number information BNi.

In addition, among the storage target data DS, the information (data) to be sorted into the deletion permission data DD and the information (data) to be sorted into the deletion non-target data DN may be changed as appropriate according to the purpose of use of the blockchain platform 100 or the like.

In the embodiment described above, the respective functions provided by the BC node 50 can be also provided by software and hardware for executing the software, only software, only hardware, and complex combinations of software and hardware. When such a function is provided by an electronic circuit as hardware, each function can also be provided by a digital circuit including a large number of logic circuits or an analog circuit.

In the embodiment described above, the processer may include at least one processing core, such as a CPU (Central Processing Unit) or a GPU (Graphics Processing Unit). The processors may further include a field-programmable gate array (FPGA), a neural network processing unit (NPU), and/or an IP core with other dedicated functions. Additionally, each of the processors is not limited to being a chip configuration in which chips are individually mounted on a printed circuit board. The processors may be incorporated in an application specific integrated circuit (ASIC), a system on chip (SoC), or a FPGA.

The form of the storage medium (non-transitory tangible storage medium), which is employed as the storage in the above embodiment and stores each program, may be changed as appropriate. For example, the storage medium is not limited to the configuration provided on the circuit board, and may be provided in the form of a memory card or the like. The storage medium may be inserted into a slot portion, and electrically connected to a computer bus. The storage medium may be an optical disc, a hard disk drive, or the like used as a source of copying or distributing a program to a computer.

The controller and its method described in the present disclosure may be implemented by a dedicated computer, which constitutes a processor programmed to execute one or more functions embodied by a computer program. Alternatively, the device and the method thereof according to the present disclosure may be implemented by a dedicated hardware logic circuit. Alternatively, the device and the method thereof according to the present disclosure may be implemented by at least one dedicated computer implemented by a combination of a processor that executes a computer program and at least one hardware logic circuit. Additionally, the computer program may be stored on a computer-readable non-transitory tangible storage medium as instructions executed by a computer.

What is claimed is:

1. An information processing method executed by at least one processor for storing storage target data by using a technology of a blockchain, the information processing method comprising:
sorting the storage target data into a plurality of data types including at least deletion permission data of which deletion is permitted and non-deletion data of which deletion is not permitted;
storing each of the deletion permission data and the non-deletion data in association with a different channel of the blockchain;
recording block number information related to a position of a processed block in which the storage target data associated with a corresponding deletion target block among a plurality of deletion target blocks is deleted, the plurality of deletion target blocks constituting a deletion target channel that stores the deletion permission data; and
determining a start position of a check process based on the block number information in the check process of confirming tampering with the deletion target channel.

2. The information processing method according to claim 1, further comprising:
storing original data related to the deletion permission data in a second storage different from a first storage that stores the deletion permission data; and
deleting the original data associated with the processed block from the second storage.

3. The information processing method according to claim 2, wherein
the deletion permission data includes a hash value generated from the original data, and
the non-deletion data includes data generated in connection with storage of the original data in the blockchain.

4. The information processing method according to claim 1, further comprising
storing disclosure limitation information that has a disclosure target limited to the deletion permission data in association with a disclosure limitation channel different from the deletion target channel.

5. The information processing method according to claim 4, further comprising:
further recording the block number information related to the position of the processed block in which the disclosure limitation information associated with a corresponding disclosure limitation block, among a plurality of disclosure limitation blocks that constitute the disclosure limitation channel, is deleted; and
determining the start position of the check process based on the block number information in the check process of confirming the tampering with the disclosure limitation channel.

6. An information processing system for storing storage target data by using a technology of a blockchain, the information processing system comprising:
a data storage configured to
sort the storage target data into a plurality of data types including at least deletion permission data of which deletion is permitted and non-deletion data of which deletion is not permitted, and
store each of the deletion permission data and the non-deletion data in association with a different channel of the blockchain; and
at least one of (i) a circuit and (ii) a processor with a memory storing computer program code executable by the processor, the at least one of the circuit and the processor configured to cause the information processing system to
record block number information related to a position of a processed block in which the storage target data associated with a corresponding deletion target block among a plurality of deletion target blocks is deleted, the plurality of deletion target blocks constituting a deletion target channel that stores the deletion permission data, and
determine a start position of a check process based on the block number information in the check process of confirming tampering with the deletion target channel.

7. A non-transitory computer-readable storage medium that stores an information processing program for storing storage target data using a technology of a blockchain, the information processing program causing at least one processor to:
sort the storage target data into a plurality of data types including at least deletion permission data of which deletion is permitted and non-deletion data of which deletion is not permitted;
store each of the deletion permission data and the non-deletion data in association with a different channel of the blockchain;
record block number information related to a position of a processed block in which the storage target data associated with a corresponding deletion target block among a plurality of deletion target blocks is deleted, the plurality of deletion target blocks constituting a deletion target channel that stores the deletion permission data; and
determine a start position of a check process based on the block number information in the check process of confirming tampering with the deletion target channel.
